(19) United States
(12) Patent Application Publication
(10) Pub. No.: US 2025/0226378 A1
(43) Pub. Date: Jul. 10, 2025

(54) ROLL-TO-ROLL DRY PROCESS FOR ELECTRODES USING ROLLERS WITH DIFFERENTIAL LINE SPEEDS TO INCREASE FIBRILLATION OF A BINDER

(71) Applicant: GM GLOBAL TECHNOLOGY OPERATIONS LLC, Detroit, MI (US)

(72) Inventors: Yong LU, Shanghai (CN); Meiyuan WU, Shanghai (CN); Dewen KONG, Shanghai (CN); Haijing LIU, Shanghai (CN)

(21) Appl. No.: 18/588,740

(22) Filed: Feb. 27, 2024

(30) Foreign Application Priority Data
Jan. 10, 2024 (CN) 202410041704.7

(51) Int. Cl. H01M 4/04

(52) U.S. Cl. CPC H01M 4/0404; H01M 4/0435

(57) ABSTRACT

A system for manufacturing an electrode for a battery cell includes N−1 pairs of rollers configured to press and calendar dry mixing materials to form an active material layer of the electrode, where N is an integer greater than one. The dry mixing materials include an active material, a conductive filler, and a binder. At least one of the N−1 pairs of rollers includes a first roller operating at a first line speed and a second roller operating at a second line speed different than the first line speed. An N^{th} pair of rollers including a third roller operating at a third line speed and a fourth roller operating at a fourth line speed that is the same as the third line speed to laminate the active material layer to a current collector.

### CROSS-REFERENCE TO RELATED APPLICATIONS

This application claims the benefit of Chinese Patent Application No. 202410041704.7, filed on Jan. 12, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to the manufacturing of electrodes of battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A system for manufacturing an electrode for a battery cell includes N−1 pairs of rollers configured to press and calendar dry mixing materials to form an active material layer of the electrode, where N is an integer greater than one. The dry mixing materials include an active material, a conductive filler, and a binder. At least one of the N−1 pairs of rollers includes a first roller operating at a first line speed and a second roller operating at a second line speed different than the first line speed. An N^{th} pair of rollers including a third roller operating at a third line speed and a fourth roller operating at a fourth line speed that is the same as the third line speed to laminate the active material layer to a current collector.

In other features, the binder comprises polytetrafluoroethylene (PTFE). The first roller and the second roller have the same diameter. The first roller has a larger diameter than the second roller. A ratio of the first line speed to the second line speed is in a range from 1.02 to 2.0. A ratio of the first line speed to the second line speed is in a range from 1.05 to 1.5. The first roller and the second roller are heated to a temperature in a range from 80° C. to 200° C.

In other features, the electrode comprises a cathode electrode. The electrode comprises an anode electrode.

A system for manufacturing an electrode for a battery cell includes N adjacent rollers to press and calendar dry mixing materials N−1 times to form an active material layer of the electrode, where N is an integer greater than two. The the dry mixing materials include an anode active material, a conductive filler, and a binder. At least two of the N adjacent rollers operating at different line speeds. An N−1^{th} one and an N^{th} one of the adjacent N rollers operating at the same line speed to laminate the active material layer onto a current collector.

In other features, the binder comprises polytetrafluoroethylene (PTFE). The at least two of the N adjacent rollers have the same diameter. The at least two of the N adjacent rollers have different diameters. A ratio of the different line speeds is in a range from 1.02 to 2.0. A ratio of the different line speeds is in a range from 1.05 to 1.5. The at least two of the N adjacent rollers are heated to a temperature in a range from 80° C. to 200° C.

In other features the electrode comprises a cathode electrode. The electrode comprises an anode electrode.

A method for manufacturing an electrode for a battery cell includes dry mixing materials for an active material layer including an active material, a conductive filler, and a binder; passing the dry mixing materials through N−1 pairs of rollers to press and calendar the dry mixing materials to form the active material layer, where N is an integer greater than one. At least one of the N−1 pairs of rollers includes a first roller operating at a first line speed and a second roller operating at a second line speed different than the first line speed. The method includes passing the active material layer and a current collector through an N^{th} pair of rollers including a third roller operating at a third line speed and a fourth roller operating at a fourth line speed that is the same as the third line speed to laminate the active material layer to the current collector.

A method for manufacturing an electrode for a battery cell includes dry mixing materials for an active material layer including an anode active material, a conductive filler, and a binder; passing the dry mixing materials N−1 times between N adjacent rollers to press and calendar the dry mixing materials to form an active material layer, where N is an integer greater than two. At least two of the N adjacent rollers operate at different line speeds. The method includes passing the active material layer and a current collector between an N−1^{th} one and an N^{th} one of the adjacent N rollers operating at the same line speed to laminate the active material layer to the current collector.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including anode electrodes, cathode electrodes, and separators according to the present disclosure;

FIG. 2 is a side cross sectional view of an example of a cathode electrode including a cathode active material layer with a fibrillated binder according to the present disclosure;

FIG. 3 is a side cross sectional view of an example of an anode electrode including an anode active material layer with a fibrillated binder according to the present disclosure;

FIG. 4 illustrates an example of rollers with the same diameter and the same line speed for pressing and heating an active material layer of an electrode;

FIG. 5A illustrates an example of rollers having the same diameter operating at different line speeds for pressing and heating an active material layer of an electrode according to the present disclosure;

FIG. 5B illustrates an example of rollers having different diameters operating at different line speeds for pressing and heating an active material layer of an electrode according to the present disclosure;

FIG. 6 illustrates an example of a roll-to-roll manufacturing process for an electrode including pairs of rollers with the same diameter operating at different line speeds according to the present disclosure;

FIG. 7 illustrates an example of a roll-to-roll manufacturing process for an electrode including pairs of rollers with different diameters operating at different line speeds according to the present disclosure;

FIG. 8 illustrates an example of a roll-to-roll manufacturing process for an electrode including a continuous groups of rollers with the same diameter operating at different line speeds according to the present disclosure;

FIG. 9 illustrates an example of a roll-to-roll manufacturing process for an electrode including a continuous group of adjacent rollers with different diameters operating at different line speeds according to the present disclosure; and

FIG. 10 is a flowchart of an example of a method for manufacturing an electrode according to the present disclosure.

In the drawings, reference numbers may be reused to identify similar and/or identical elements.

### DETAILED DESCRIPTION

While battery cells according to the present disclosure are described in the context of vehicles, the battery cells can be used in other applications such as stationary applications.

Electrodes such as cathode or anode electrodes include an active material layer that is arranged on one or both sides of a current collector. The active material layer may be manufactured by mixing an anode active material, a conductive filler, and binder. In a wet process, solvent is added to the mixture of materials forming the active material layer. After casting the active material layer onto the current collector, the electrode may be heated by a drying stage after casting to remove the solvent. The use of the drying stage increases the cost of manufacturing and the manufacturing footprint of the roll to roll equipment. Use of the solvent may be associated with environmental issues.

Dry processes that do not add solvent to the active material layer may also be used. In a dry process, the binder (e.g., polytetrafluoroethylene (PTFE)) is fibrillated by dry mixing and applying pressure to the active material layer using one or more pairs of calendaring rollers with the same diameter and operating at the same line speed. When using traditional pairs of rollers having the same diameter and operating at the same speed, the active material layer mainly experiences pressing force transverse to a plane including the active material layer.

Sufficient fibrillation of the binder is important for a scalable, high-quality dry electrode fabrication process. Typically, processing of the raw materials forming the active material layer includes dry powder mixing, powder-to-film calendaring, and laminating the active material layer onto the current collector to form the electrode. One or more calendaring/rolling steps are used to control thickness uniformity. However, due to the poor fluidity of dry powders, it is easy to over-press some areas of the active material layer which causes electrode thickness variations and thickness limitations.

The present disclosure relates to a dry manufacturing process for electrodes using calendaring rollers with differential line speeds. For example, the active material layer is pressed and heated between pairs of rollers with the same diameter and different line speeds or pairs of rollers with different diameters and different line speeds.

When using pairs of rollers operating at different line speeds, the active material layer experiences pressing force transverse to a plane including the active material layer and shear force in a direction parallel to the active material layer due to the differential line speeds. The shear force increases PTFE fibrillation and overcomes the issue of over-calendaring of localized areas of the active material layer.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include cathode active material layers 24 arranged on one or both sides of a cathode current collector 26.

In some examples, the A anode electrodes 40 and the C cathode electrodes 20 exchange lithium ions during charging/discharging. The A anode electrodes 40-1, 40-2, . . . , and 40-A include anode active material layers 42 arranged on one or both sides of the anode current collectors 46. In some examples, one or both of the cathode active material layers 24 and/or the anode active material layers 42 comprise dry coatings including one or more active materials, one or more conductive additives, and/or one or more binder materials that are applied to the current collectors. The binder materials include at least one binder (e.g., PTFE) that can be fibrillated.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

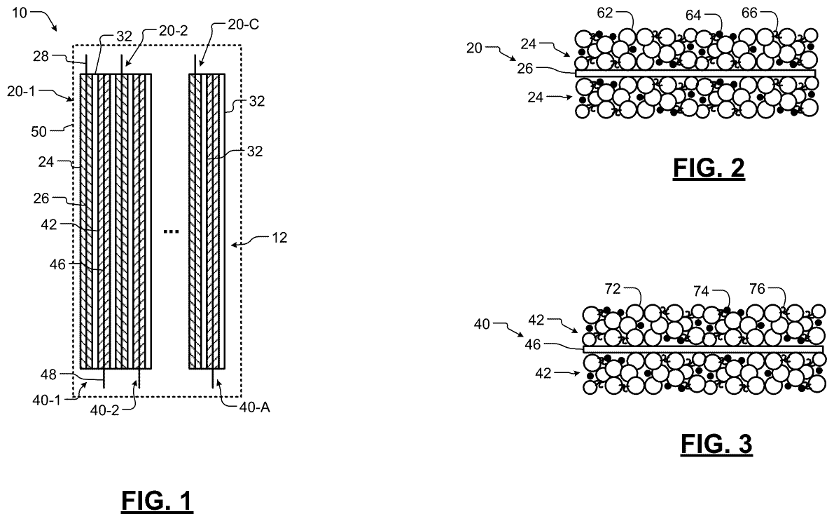

Referring now to FIGS. 2 and 3, examples of cathode electrodes and anode electrodes are shown. In FIG. 2, one of the C cathode electrodes 20 is shown in further detail. The cathode active material layer 24 of the C cathode electrodes 20 includes cathode active material 62, a conductive additive 64, and a binder 66 that can be fibrillated. In some examples, the binder 66 includes PTFE. In FIG. 3, one of the A anode electrodes 40 is shown in further detail. The anode active material layer 42 of the anode electrode 40 includes anode active material 72, a conductive additive 74, and a binder 76 that can be fibrillated. In some examples, the binder 76 includes PTFE.

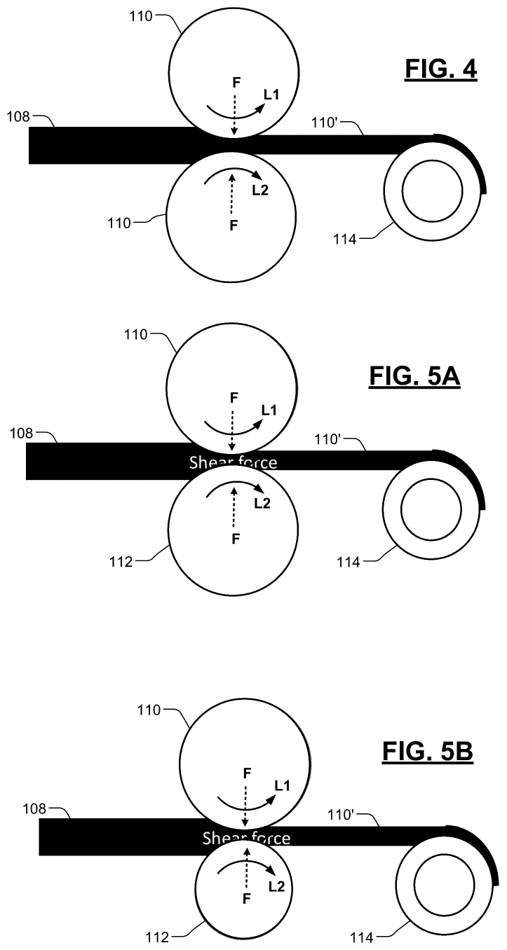

Referring now to FIG. 4, an active material layer (e.g., cathode or anode active material layer) is manufactured by dry mixing the active material, the conductive additive, and the binder. Typically, a mixture 108 is pressed and/or heated between pairs of rollers 110 and 112. In FIG. 4, the rollers 110 and 112 have the same diameters and the same line speeds (e.g., L₁ and L₂).

When the rollers are operated at the same line speed, problems may occur. The rollers provide pressing force mainly in one direction (e.g., perpendicular to the active material layer). The rollers may get stuck due to non-uniformity of the dry powder mixture that is fed causing localized over-pressing on the electrode films (e.g., causing cracks or failure). Electrode thickness variations and/or insufficient fibrillation may occur resulting in low mechanical strength of the electrode.

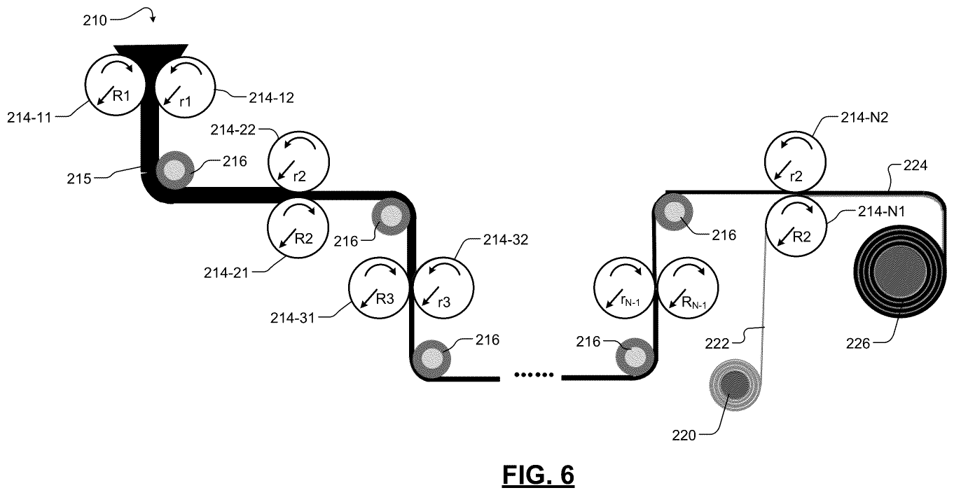

In FIG. 5A, during manufacturing of electrodes according to the present disclosure, a roll-to-roll process utilizes one or more pairs of rollers with the same diameters and different line speeds L₁ and L₂ where L₁≠L₂. The different line speeds can be accomplished using two different drive motors driving the rollers at different speeds or a single motor driving at least one of the rollers via a gear with a different gear ratio. As a result of the speed differential, the rollers apply pressing force perpendicular to the active material layer and shear force parallel to the active material layer. In FIG. 5B, one or more pairs of rollers with different diameters can also be used to provide different line speeds L₁ and L₂ where L₁≠L₂.

Referring now to FIG. 6, the manufacturing method according to the present disclosure uses rollers with differential line speeds to produce sufficient shear force to boost PTFE fibrillation by enhancing the frictional motion between particles. A mixture 215 for an active material layer is fed at 210 between a pair of rollers 214-11 and 214-12 (having line speeds R₁ and r₁, respectively). After being pressed and/or heated, the mixture 215 is fed around one or more guide rollers 216 between rollers 214-21 and 214-22 (having line speeds R₂ and r₂, respectively).

After being pressed and/or heated, the mixture 215 is fed around one or more guide rollers 216 between rollers 214-31 and 214-32 (R₃ and r₃, respectively). After being pressed and/or heated, the mixture 215 is fed around one or more guide rollers 216 between rollers 214-N1 and 214-N2, where N1 and N2 are integers greater than one (RN and IN, respectively). A substrate 222 (e.g., a current collector with an adhesive coating) is fed from a roller 220 between the rollers 214-N1 and 214-N2 to laminate the active material layer and the current collector to form an electrode 224. The electrode 224 is collected onto roll 326.

Line speeds of RN and IN are defined as LN and IN, respectively. LN−1≠IN−1 and LN=IN (where N≥2). At least two groups of rollers (RN=rN, N≥2) are used for calendaring dry powder mixture into an active material layer and laminating the active material layer onto the current collector. In some examples, at least 1 pair and up to N−1 pairs of rollers have different line speeds where a ratio of LN−1/IN−1 is in a range from 1.05 to 2 and a ratio of LN/IN=1.0. In some examples, at least 1 pair and up to N−1 pairs of rollers have different line speeds where a ratio of LN−1/IN−1 is in a range from 1.02 to 1.5. All the rollers can be heated to a temperature in a range from 40° C. to 200° C. The rollers in each pair of rollers have the same diameter on a pair basis or all rollers.

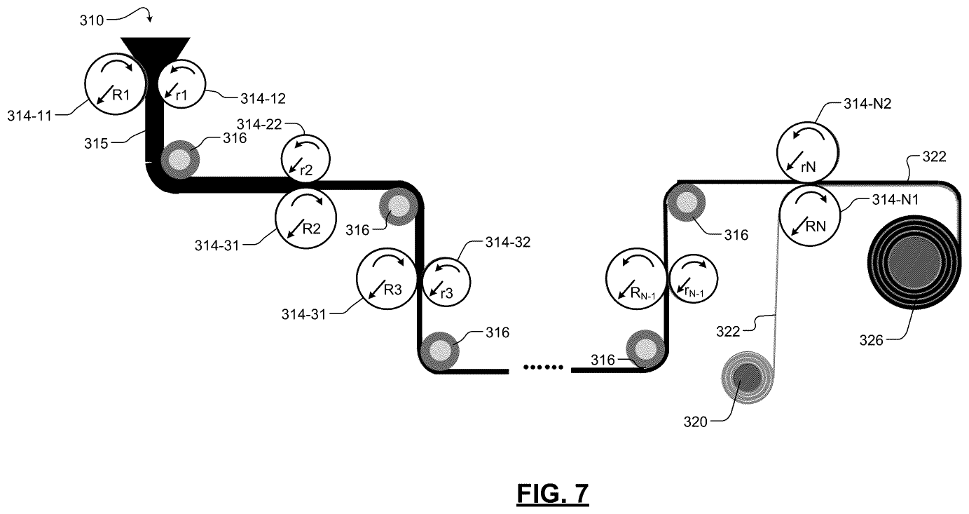

Referring now to FIG. 7, a mixture 315 for an active material layer is fed at 310 between a pair of rollers 314-11 and 314-12. After being pressed and/or heated, the mixture 315 is fed around one or more guide rollers 316 between rollers 314-31 and 314-22. After being pressed and/or heated, the mixture 315 is fed around one or more guide rollers 316 between rollers 314-31 and 314-32. After being pressed and/or heated, the mixture 315 is fed around one or more guide rollers 316 between rollers 314-N1 and 314-N2, where N1 and N2 are integers greater than one. A substrate 322 (e.g., a current collector with an adhesive coating) is fed from a roller 320 between the rollers 314-N1 and 314-N2 to form an electrode 324. The electrode 324 is collected onto roll 326.

Define line speeds of RN and IN as LN and IN, respectively. RN−1≠rN−1 and RN=rN (where N≥2) and LN−1≠IN−1 and LN=IN (where N≥2). At least two pairs of rollers are used where at least 1 pair and up to N−1 pairs of rollers have different roller diameters to enable differential line speeds where a ratio of LN−1/IN−1 is in a range from 1.05 to 2.0 and LN/IN=1.0. As can be appreciated, one control motor can be used for each pair of rollers to reduce costs. All the rollers can be heated to a temperature in a range from 40° C. to 200° C.

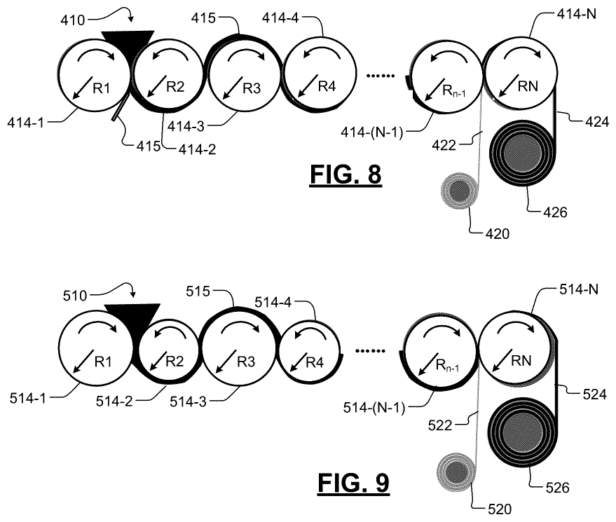

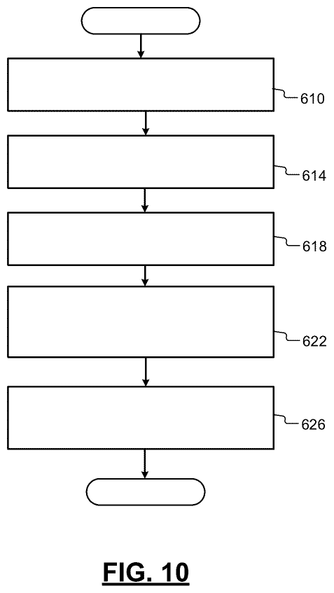

Referring now to FIGS. 8 and 9, continuous groups of rollers can be controlled with different line speeds (e.g., with the same or different diameters). Differential line speeds/roller diameter designs of adjacent group of rollers are applied to enable additional shear force to boost PTFE fibrillation. The dry powder mixture is fed between adjacent pairs of rollers. In other words, the dry powder mixture is fed between a first and second roller, a second and third roller, and so on. Opposite sides of each of the rollers are used to press and/or heat the active material layer twice (e.g., once between the roller and an adjacent roller on one side and then between the roller and an adjacent roller on the opposite side).

In FIG. 8, the dry powder mixture is fed between rollers 414-1 and 414-2 and between rollers 414-3, 414-4, . . . , and 414-N. In some examples, a blade 415 may be used to bias the active material layer towards a downstream roller. A substrate 422 is fed between the rollers 414-N−1 and 414-N to create an electrode 424 that is collected on a roll 426. All of the rollers 414-1, 414-2, . . . and 414-N have the same diameter. Line speeds of RN are defined as LN where LN−1=IN (where N≥2) for lamination and at least one adjacent group of rollers (from 1 to N−1) have differential line speeds.

In FIG. 9, the dry powder mixture is fed between rollers 514-1 and 514-2 and between rollers 514-3, 514-4, . . . , and 514-N. A substrate 522 is fed between the rollers 514-N−1 and 514-N to create an electrode 524 that is collected on a roll 526. All of the rollers 514-1, 514-2, . . . and 514-N have the same diameter. Roller size RN−1=RN (where N≥2) for lamination and at least one adjacent group of rollers (from 1 to N−1) have differential roller diameters.

Referring now to FIG. 10, a method for manufacturing an electrode is shown. At 610, a dry powder mixture including active materials and conductive additive is mixed. At 614, PTFE binder is added to the mixture. At 618, the mixture is fibrillated with high shear force. At 622, the dry mixture is passed through at least one pair of rollers having differential line speed to create shear force to fibrillate the binder. At 626, the mixture is laminated onto a current collector to form an electrode.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A system for manufacturing an electrode for a battery cell, comprising:
N−1 pairs of rollers configured to press and calendar dry mixing materials to form an active material layer of the electrode, where N is an integer greater than one,
wherein the dry mixing materials include an active material, a conductive filler, and a binder;
at least one of the N−1 pairs of rollers includes a first roller operating at a first line speed and a second roller operating at a second line speed different than the first line speed; and
an Nth pair of rollers including a third roller operating at a third line speed and a fourth roller operating at a fourth line speed that is the same as the third line speed to laminate the active material layer to a current collector.

2. The system of claim 1, wherein the binder comprises polytetrafluoroethylene (PTFE).

3. The system of claim 1, wherein the first roller and the second roller have the same diameter.

4. The system of claim 1, wherein the first roller has a larger diameter than the second roller.

5. The system of claim 1, wherein a ratio of the first line speed to the second line speed is in a range from 1.02 to 2.0.

6. The system of claim 1, wherein a ratio of the first line speed to the second line speed is in a range from 1.05 to 1.5.

7. The system of claim 1, wherein the first roller and the second roller are heated to a temperature in a range from 80° C. to 200° C.

8. The system of claim 1, wherein the electrode comprises a cathode electrode.

9. The system of claim 1, wherein the electrode comprises an anode electrode.

10. A system for manufacturing an electrode for a battery cell, comprising:
N adjacent rollers to press and calendar dry mixing materials N−1 times to form an active material layer of the electrode, where N is an integer greater than two,
wherein the dry mixing materials include an anode active material, a conductive filler, and a binder;
at least two of the N adjacent rollers operating at different line speeds; and
an N−1^{th} one and an N^{th} one of the adjacent N rollers operating at the same line speed to laminate the active material layer onto a current collector.

11. The system of claim 10, wherein the binder comprises polytetrafluoroethylene (PTFE).

12. The system of claim 10, wherein the at least two of the N adjacent rollers have the same diameter.

13. The system of claim 10, wherein the at least two of the N adjacent rollers have different diameters.

14. The system of claim 10, wherein a ratio of the different line speeds is in a range from 1.02 to 2.0.

15. The system of claim 10, wherein a ratio of the different line speeds is in a range from 1.05 to 1.5.

16. The system of claim 10, wherein the at least two of the N adjacent rollers are heated to a temperature in a range from 80° C. to 200° C.

17. The system of claim 10, wherein the electrode comprises a cathode electrode.

18. The system of claim 10, wherein the electrode comprises an anode electrode.

19. A method for manufacturing an electrode for a battery cell, comprising:
dry mixing materials for an active material layer including an active material, a conductive filler, and a binder;
passing the dry mixing materials through N−1 pairs of rollers to press and calendar the dry mixing materials to form the active material layer, where N is an integer greater than one,
wherein at least one of the N−1 pairs of rollers includes a first roller operating at a first line speed and a second roller operating at a second line speed different than the first line speed; and
passing the active material layer and a current collector through an Nth pair of rollers including a third roller operating at a third line speed and a fourth roller operating at a fourth line speed that is the same as the third line speed to laminate the active material layer to the current collector.
